(19) United States
(12) Patent Application Publication
(10) Pub. No.: US 2022/0126263 A1
(43) Pub. Date: Apr. 28, 2022

(54) MATRIX INTEGRATING AT LEAST ONE HEAT EXCHANGE FUNCTION AND ONE DISTILLATION FUNCTION

(71) Applicant: L'air Liquide, Société Anonyme Pour l'Etude et l'Exploitation des Precédés Georges Claude, Paris (FR)

(72) Inventor: Jean-Pierre TRANIER, L'Hay-les-Roses (FR)

(21) Appl. No.: 17/433,183

(22) PCT Filed: Feb. 25, 2020
(86) PCT No.: PCT/FR2020/050355

§ 371 Date: Aug. 23, 2021

(30) Foreign Application Priority Data
Feb. 25, 2019 (FR) 1901868
Feb. 25, 2019 (FR) 1901869
Feb. 25, 2019 (FR) 1901872

(51) Int. Cl. B01J 19/32; F25J 3/04; F25J 5/00; F28D 21/00

(52) U.S. Cl. CPC B01J 19/32; F25J 3/0463; F25J 5/007; F25J 2290/44; B01J 2219/32213; B01J 2219/32272; F25J 2200/04; F28D 21/0015

(57) ABSTRACT

A matrix, configured to form at least part of a material-transfer separation unit, the matrix having a stack of several plates arranged parallel to one another in a direction known as the direction of stacking, thereby defining passages, the matrix having a length, a width and a thickness, the length of a matrix being the greatest dimension of the parallel plates, the width of the matrix being measured perpendicular to the length, and the thickness of the matrix being measured in the direction of stacking of the plates.

### CROSS REFERENCE TO RELATED APPLICATIONS

This application is a 371 of International Patent Application No. PCT/FR2020/050355, filed Feb. 25, 2020, which claims priority to French Patent Application Nos. 1901868, 1901869, and 1901872, all filed Feb. 25, 2019, the entire contents of which are incorporated herein by reference.

### BACKGROUND

The present invention relates to a matrix integrating at least a heat exchange function and a distillation function.

The present invention relates to a matrix intended to form at least part of a distillation-separation unit, for example a cryogenic air-gas separation apparatus. The matrix, which is preferably a brazed aluminum matrix, integrates at least a heat exchange function and a distillation function.

In the prior art, a cryogenic air separation unit generally comprises brazed-plate heat exchangers that form in particular the main heat exchange line of the cryogenic air separation unit and the vaporizer-condenser placing the medium-pressure column and the low-pressure column in a heat exchange relationship. These two distillation columns in which material transfer is carried out are not integrated into the brazed matrices that constitute these brazed-plate heat exchangers.

EP0767352 proposes integrating into these brazed matrices a dephlegmation function, i.e. a zone in which heat exchange and material transfer are carried out simultaneously.

U.S. Pat. No. 6,295,839 proposes integrating distillation and heat exchange functions into a brazed matrix, but it does not describe how to design such a brazed matrix (also called a “core”) so as to have a solution that can be brazed and that has the necessary mechanical strength to withstand the operating pressure.

A brazed matrix comprises a stack of parallel plates delimiting fluid passages, as well as heat-exchange corrugations or spacers that define channels for these fluids. Peripheral sidebars seal the fluid passages.

The scientific publication “The structured heat integrated distillation column”, Bruinsma O. S. L. et al., Chem Eng Res Des (2012) compares the performance of conventional corrugations of exchangers made of brazed aluminum as described in the ALPEMA document “The standards of the brazed aluminium plate-fin heat exchanger manufacturer' association” with brazed cross-corrugated packing in a matrix.

In the case of the cross-corrugated packing, in order to ensure the mechanical strength, a 1 mm perforated separator sheet is inserted before brazing between the two corrugated sheets so as to braze the whole. The efficiency of the conventional corrugation is very poor, with an HETP (height equivalent to a theoretical plate) of about 1.4 meters. The efficiency of the cross-corrugated packing is better, with HETPs of between 0.2 and 0.4 meters. Nevertheless, if it were desired to increase the efficiency of the packing, it would be necessary to increase the density thereof, typically beyond 1000 m2/m3 or even 1500 m2/m3 so as to have HETPs smaller than 100 mm. To this end, the height of the corrugations would change from 8-9 mm to 3-4 mm and would make it necessary to double the number of separator sheets.

U.S. Pat. No. 5,144,809 describes a matrix having a smaller cross section with a heat-exchange function and a distillation function in a body made up of a stack of plates. The passages dedicated to distillation are separated from one another by passages the upper part of which is used for vaporizing rich liquid and the lower part of which is empty.

### SUMMARY

The present invention aims to propose a material-transfer apparatus which is efficient (for example making it possible to have HETPs smaller than 100 mm), which can withstand pressure, which is easy to manufacture at low cost and into which it is possible to incorporate the indirect heat exchange.

According to the present invention, most if not all of the passages of the second zone have the same function.

In a way known per se, such a brazed matrix has the overall shape of a rectangular parallelepiped. Its length is typically from 4 to 8 m, its width from 1 to 1.5 m and its height from 1 to 2 m. By convention, the length of a brazed matrix is the greatest dimension of the parallel plates delimiting fluid passages. The width of a heat exchanger is measured perpendicular to the length. The height of a heat exchanger is measured in the direction of stacking of its plates. In this patent, the height of the matrix will also be referred to as the thickness of the matrix or the matrix stack.

The present invention notably aims to overcome the problems with the brazing and with the mechanical strength of the brazed matrix while at the same time providing the process functions of such a matrix.

To this end, one subject of the invention is a matrix, intended to form at least part of a material-transfer separation unit, for example for using distillation to separate air into a nitrogen-enriched fraction and an oxygen-enriched fraction combined with a unit for indirect heat transfer between a primary fluid and a secondary fluid, for example so as to condense the nitrogen-enriched fraction as primary fluid in exchange for the vaporizing of the oxygen-enriched fraction or of an oxygen-rich fluid derived from the oxygen-enriched fraction by way of secondary fluid,
said matrix comprising a stack of several plates arranged parallel to one another in a direction known as the direction of stacking, defining passages, the matrix having a length, a width and a thickness, the length of a matrix being the greatest dimension of the parallel plates, the width of the matrix being measured perpendicular to the length, and the thickness of the matrix being measured in the direction of stacking of its plates,
each plate having the same length and the same width as the matrix,
the matrix comprising at least two zones, including a first zone referred to as indirect heat-transfer zone, defined by a first fraction of the length of the matrix, at least half the total width of the matrix and at least half the total thickness of the matrix, and a second zone referred to as the distillation-separation zone, defined by a second fraction of the length of the matrix, at least half the total width of the matrix and at least half the total thickness of the matrix,
the first zone and the second zone being connected and the matrix being constructed to allow fluid coming from just some of the passages of the first zone to communicate with the passages of the second zone, and to allow fluid coming from the passages of the second zone to communicate with just some of the passages of the first zone,
the collection of passages of the first zone having a dimension which is the first fraction of the length of the matrix, a dimension which is at least at least half the total width of the matrix, and a dimension which is at least at least half the thickness of the matrix,
the passages of the first zone containing means to encourage indirect heat transfer and possibly material transfer, and the passages of the second zone containing means to encourage the transfer of material between a liquid phase and a gas phase,
the passages of the first zone consisting of a first series of passages to channel at least one refrigerating or heating fluid, the passages of the first series not being in fluidic communication with the second zone, and a second series of passages for channelling a fluid produced by distillation in the second zone, the passages of the second series being in fluidic communication with the second zone, the passages of the first zone being dosed in order to prevent the fluid produced by the material transfer from entering the first series and in order to prevent the refrigerating or heating fluid from entering the second series,
the collection of passages of the second zone having a dimension which is the second fraction of the length of the matrix, a dimension which is at least half the total width of the matrix, and a dimension which is at least half the thickness of the matrix, each passage being defined between two successive plates and extending parallel to a longitudinal axis,
the number of passages in the first zone being strictly greater than the number of passages in the distillation second zone and preferably a multiple of the number of passages in the second zone.

According to other optional aspects:
the number of passages in the first zone is at least twice, or even at least three times, or even at least eight times as high as the number of passages in the second zone,
the passages in the first zone contain means for encouraging the indirect transfer of heat and selected from the group: straight corrugations, perforated corrugations, serrated (partially offset) corrugations, louvered corrugations and herringbone corrugations,
the passages of the second zone contain means for encouraging the transfer of material between a liquid phase and a gas phase and chosen from the group: structured packings made up of superposed corrugated strips, possibly contained within a row of polygonal-section columns, random-fill packings, possibly contained within a row of polygonal-section columns,
the matrix comprises at least a third zone referred to as a material-transfer zone adjoining the first zone, the matrix being constructed in such a way as to allow fluid from the passages of the first zone to communicate with the passages of the third zone and fluid from the passages of the third zone to communicate with the passages of the first zone, throughout the section, the third zone, referred to as the second material-transfer zone, defined by a third fraction of the length of the matrix, at least half the total width of the matrix and at least half the total thickness of the matrix,
the passages of the third zone having a dimension which is a third fraction of the length of the matrix, a dimension which is at least half the total width of the matrix, and a dimension which is at least half the thickness of the matrix,
the passages of the third zone containing means to encourage material transfer, the number of passages in the first zone is strictly greater than the number of passages in the distillation third zone and preferably a multiple of the number of passages in the third zone,
a the matrix comprises at least a third zone referred to as an indirect heat-transfer zone adjoining the second zone, the matrix being constructed in such a way as to allow fluid from the passages of the second zone to communicate with the passages of the third zone and/or fluid from the passages of the third zone to communicate with the passages of the second zone, throughout the section, the third zone, referred to as the second indirect heat-transfer zone, defined by a third fraction of the length of the matrix, at least half the total width of the matrix and at least half the total thickness of the matrix,
the passages of the third zone having a dimension which is a third fraction of the length of the matrix, a dimension which is at least half the total width of the matrix, and a dimension which is at least half the thickness of the matrix,
the passages of the third zone containing means for encouraging indirect heat transfer and possibly material transfer,
the number of passages in the third zone is strictly greater than the number of passages in the material-transfer second zone and preferably a multiple of the number of passages in the second zone,
the first zone is defined by at least three quarters of the total width of the matrix, or even the entire width,
the first zone is defined by at least three quarters of the total thickness of the matrix, or even the entire thickness,
the second zone is defined by at least three quarters of the total width of the matrix, or even the entire width,
the second zone is defined by at least three quarters of the total thickness of the matrix, or even the entire thickness,
the number of passages in the third zone is equal to the number of passages in the second zone,
the number of passages in the third zone is equal to the number of passages in the first zone,
the passages of the first or the second zone are connected to a distillation column comprising a cylindrical shell ring and, inside the shell ring, cross-corrugated packing modules,
the passages of the second zone being connected to a heat exchanger, possibly consisting of one zone of the matrix,
the plates are made of aluminum,
the means for encouraging the transfer of material between a liquid phase and a gas phase in the passages of the second zone are not brazed to the plates of each passage,
the means for encouraging the exchange of heat in the passages of the first zone are brazed to the plates of each passage,
the passages of the second zone are each defined between two adjacent plates of the matrix,
at least one planar element is arranged between each pair of adjacent plates, the planar element being parallel to the plates and dividing the space between two plates in the first zone to define the passages of the first zone,
the passages of the first series and of the second series of the first zone have a shortest dimension which is at least a factor of two smaller than the shortest dimension of the passages of the second zone,
the passages of the first zone are between at least one planar wall parallel to the plates and i) one of the plates or ii) another planar wall parallel to the plates,
the passages of the first series each lie between two passages of the second series, and the passages of the second series each lie between two passages of the first series, with the exception of the passages at the edges of the matrix,
a part of the first, second or third zone may have a function different than that of another part of that same zone,
in the first zone, at least one planar wall is arranged between and parallel to a pair of adjacent plates,
the matrix comprises means for supplying all the passages of the second zone with the same fluid,
the matrix comprises means for sending gas from each passage of the second zone to just some of the passages of the first zone across the entire section,
the second zone comprises, or even consists of, a multitude of passages adjacent to one another,
the second zone is defined by a second fraction of the length of the matrix,
at least half the total width of the matrix, and the total thickness of the matrix, which is to say the stack.

Another aspect of the invention envisions an apparatus for separating a gas mixture having at least two components using a matrix as claimed in one of the preceding claims, the passages of the first zone each having a first end and a second end, the passages of the second zone each having a first end and a second end, the second ends of the passages of the first zone being juxtaposed with the first ends of the passages of the second zone, the apparatus comprising means for sending the cooled and purified gas mixture into the second ends of at least the majority of the passages, and preferably all the passages, of the second zone, means for extracting a liquid enriched in one component of the gas mixture from the second ends of the passages, preferably of all the passages, as well as:

i) means for sending a refrigerating fluid into the first series of the passages of the first zone and means for sending a gas that is to be condensed into the second series of the passages of the first zone, and/or

ii) means for sending a heating fluid into the first series of the passages of the first zone and means for sending a liquid that is to be vaporized into the second series of the passages of the first zone.

Another subject-matter of the invention provides a method for separating a gas mixture by cryogenic distillation wherein the distillation is performed by means of a matrix as described hereinabove or an apparatus as described hereinabove, and wherein:

i) A gas produced by the distillation of the gas mixture in the second zone condenses in the first zone through exchange of heat with a refrigerating fluid, and/or

ii) A liquid produced by the distillation of the gas mixture vaporizes in the second zone through exchange of heat with a heating fluid.

The embodiments of the invention and the variants of the invention, which are mentioned above, can be considered separately or according to any technically possible combination.

### BRIEF DESCRIPTION OF THE DRAWINGS

The present invention will be clearly understood and its advantages will also become apparent in the light of the description which now follows, which is given solely by way of nonlimiting example and with reference to the appended drawings, in which;

FIG. 1A is a schematic perspective view of a brazed aluminum matrix according to a first embodiment of the invention;

FIG. 1B illustrates a variant of a detail of FIG. 1A;

FIG. 1C illustrates a variant of a detail of FIG. 1A;

FIG. 2 is a schematic view combining a matrix according to the invention with a conventional distillation column;

FIG. 3 is a schematic perspective view of other embodiments of the invention, in which multiple zones for the transfer of material and/or for the indirect transfer of heat possibly associated with the transfer of material are created;

FIG. 4 is a schematic perspective view of other embodiments of the invention, in which multiple zones for the transfer of material and/or for the indirect transfer of heat possibly associated with the transfer of material are created;

FIG. 5A depicts a passage layout of a variant of the invention;

FIG. 5B depicts a passage layout of a variant of the invention;

FIG. 5C depicts a passage layout of a variant of the invention;

FIG. 5D depicts a side view of a variant of the invention;

FIG. 6A depicts a variant of the invention;

FIG. 6B depicts a variant of the invention;

FIG. 6C depicts a variant of the invention;

FIG. 6D depicts a variant of the invention;

FIG. 7A depicts a variant of the invention.

FIG. 7B depicts a variant of the invention;

FIG. 7C depicts a variant of the invention;

FIG. 7D depicts a variant of the invention;

### DETAILED DESCRIPTION OF PREFERRED EMBODIMENTS

In the following part of the description, the term “transfer of material” or “material transfer” will characterize zones in which there is direct contact between at least two fluids. These two fluids are preferably a gas and a liquid but could be two liquids or two gases. Distillation is among the methods that employ material transfer. Note that there may also be a “direct heat transfer” which means to say one with contact associated with the material transfer.

The term “indirect heat transfer” or “indirect transfer of heat” will characterize zones in which there is an exchange of heat without direct contact between two fluids, a primary fluid and a secondary fluid. If there is no change to the composition of the primary and secondary fluids between the inlet and the outlet, then the exchange is one of heat in the strictest sense. In the event that there is a change in the composition of the primary fluid and/or of the secondary fluid between the inlet and the outlet, then this is referred to as dephlegmation. For example, in the case of the separation of the air gases, the nitrogen-enriched fraction in the medium-pressure column may continue to become enriched in nitrogen in a condenser-dephlegmator from which the fluid exits at the bottom in the form of a liquid fraction that is not enriched in nitrogen and at the top as a nitrogen-enriched gas.

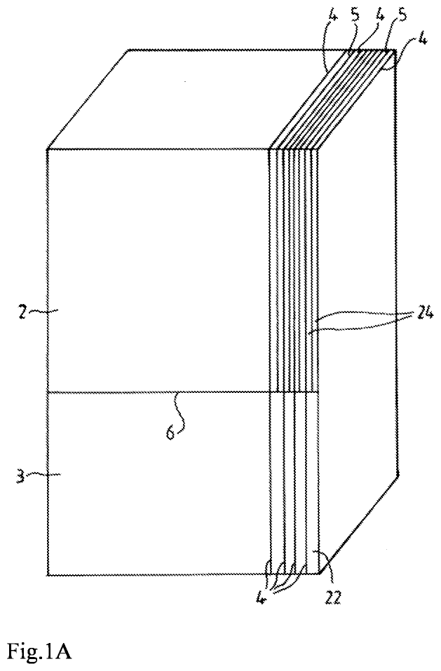

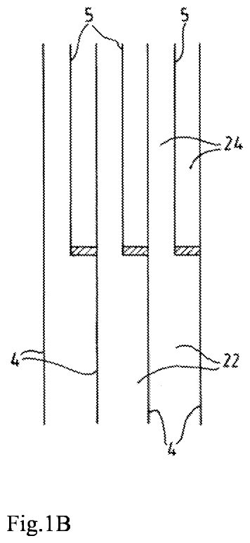

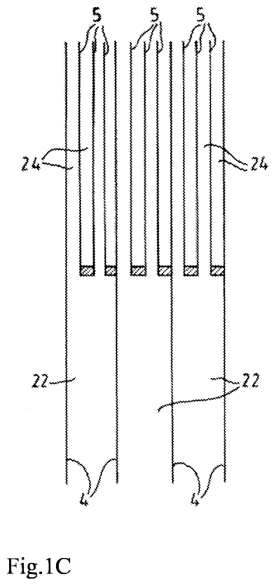

FIG. 1A illustrates a matrix 1 intended to form at least part of a distillation separation unit, or even to form, in itself, a distillation separation unit. It could be used to separate air into a nitrogen-enriched fraction and an oxygen-enriched fraction.

Thus, the air would be separated in a first part of the matrix, and another part of the matrix would be used for allowing indirect heat transfer between a primary fluid and a secondary fluid, for example so as to condense the nitrogen-enriched fraction as primary fluid in exchange for the vaporizing of the oxygen-enriched fraction or of an oxygen-rich fluid derived from the oxygen-enriched fraction by way of secondary fluid.

The primary fluid and/or the secondary fluid could be produced by the distillation of a mixture in the material-transfer part of the matrix.

The matrix 1 comprises a stack of several rectangular plates 4 arranged parallel to one another in a direction known as the direction of stacking, the matrix having a length, a width and a height, the length of a matrix being the greatest dimension of the parallel plates, the width of the matrix being measured perpendicular to the length, and the height of the matrix being measured in the direction of stacking of its plates. Each plate 4 has the same length and the same width as the matrix 1 and may be made of aluminum. It is these plates 4 that provide the framework that gives the brazed matrix its mechanical strength.

The matrix comprises at least two zones, including a first zone 2 referred to as indirect heat-transfer zone, defined by a first fraction of the length of the matrix, the total width of the matrix and the total thickness of the matrix, and a second zone 3 referred to as the material-transfer zone, defined by a second fraction of the length of the matrix, the total width of the matrix and the total thickness of the matrix.

The line 6 illustrates the division between the two zones 2, 3 but does not correspond to a means separating them.

In this example, the zone 2 is arranged above the zone 3, but the reverse is possible.

The first zone 2 and the second zone 3 are connected and the matrix is constructed to allow fluid coming from just some of the passages of the first zone to communicate with the passages of the second zone, and to allow fluid coming from the passages of the second zone to communicate with just some of the passages of the first zone, over the entire section. The passages of the first series are not in fluidic communication with the second zone 2, and the passages of the second series are in fluidic communication with the second zone 3.

The first zone 2 comprises, and preferably consists of, a multitude of passages 24 adjacent to one another.

The second zone 3 comprises, and preferably consists of, a multitude of passages 22 adjacent to one another.

The passages 24 of the first zone 2 have a dimension which is the first fraction of the length of the matrix, a dimension which is the total width of the matrix, and a dimension which is a fraction of the height of the matrix.

The passages 24 of the first zone 2 contain means for encouraging the indirect exchange of heat, and possibly the transfer of material, the means for encouraging the exchange of heat being selected from the group: straight corrugations, perforated corrugations, serrated (partially offset) corrugations, louvered corrugations, herringbone corrugations, structured packings, random-fill packings.

The passages 22 of the second zone 3 contain means for encouraging the transfer of material between a liquid phase and a gas phase and chosen from the group: structured packings made up of superposed corrugated strips, random-fill packings, possibly contained within a row of polygonal-section columns.

The passages 24 of the first zone 2 consist of a first series of passages 54, 62, 72 to channel at least one refrigerating or heating fluid, and a second series 53, 55, 60, 61, 70 of passages for channelling a fluid produced by distillation in the second zone, the passages being closed in order to prevent the fluid produced by distillation from entering the first series and in order to prevent the refrigerating or heating fluid from entering the second series.

The passages 22 of the second zone 3 have a dimension which is the second fraction of the length of the matrix, a dimension which is the total width of the matrix, and a dimension which is a fraction of the height of the matrix, each passage being defined between two successive plates and extending parallel to a longitudinal axis.

The number of passages in the first zone 2 is strictly greater than the number of passages in the second zone 3 and preferably a multiple of the number of passages in the second zone.

The passages 22 of the second zone 3, 7, 8, 9 are all supplied with the same gas that is to be distilled and produce a light component enriched gas at the top of the passages, and a heavy component enriched liquid at the bottom of the passages.

Gas is sent from each passage 22 of the second zone 3, 7, 8, 9 to just some of the passages of the first zone 2.

Thus, all the passages 22 of the second zone have the same function.

In the example, air is sent to most of the passages 22 of the second zone, or even to all the passages. There, the air is separated to form a nitrogen-rich gas at the top of the passages 22, while an oxygen-enriched liquid descends toward the bottom of the passages 22. The nitrogen-rich gas enters one passage 24 in two of the passages of the first zone 2.

There is an exchange of heat with a refrigerating fluid sent into one passage 24 in of the passages of the first zone 2 so that the nitrogen is heated through the planar walls formed by plates 5 of the first zone.

The plates 5 (planar elements) have the height of the first zone and the width of the matrix. They are arranged in parallel with the plates 4 in the space between two plates 4 in order to subdivide the passages between two plates 4 into a plurality of passages 24.

By fitting a single plate 5, two passages 24 are obtained, having half the width of a passage 22.

By fitting a three plates 5, four passages 24 are obtained, having one quarter of the width of a passage 22.

For example, the number of passages in the indirect heat-transfer zone is at least a factor of two times, or even three times, or even four or eight times the number of passages in the material-transfer separation zone.

As a preference, the number of passages 22 in the second zone 3 is multiplied by an even number in order to obtain the number of passages 24 in the first zone 2, for example in order to have an alternation of a refrigeration passage with a heating passage.

Another preferred embodiment of the invention is to choose a number of passages 22 in the zone 3 that is multiplied by a number which is a multiple of 3 (preferably 3, 6 or 9), so as to have 2 heating passages flanking 1 refrigerating passage (or possibly the reverse). In that case, a heating passage may operate as a condenser-dephlegmator to provide reflux for the zone 3 (without a specific liquid distribution device. The gas exiting at the top of this passage feeds into the heating second passage which is a conventional condenser so as to produce the liquid that will provide reflux for a low-pressure column. In the above instance of an even number of passages condenser-dephlegmator and conventional condenser may be superposed with a lateral outlet for the gas.

Otherwise, it is possible to have just a conventional condenser supplied with gas from above. In that case it would be necessary to have, at the bottom of the zone 2, a liquid extraction device for supplying the low-pressure column and a device for distributing the liquid in the zone 3.

Other ways of subdividing the space between the two plates 4 may be envisioned. Rather than adding at least one plate 5 or in addition to adding at least one plate 5, columns could be added.

The zones 2, 3 are connected in such a way that the nitrogen cannot enter the passages intended for the refrigerating fluid and in such a way that the refrigerating fluid cannot pass into the second zone.

Thus, the nitrogen condenses in a part of the passages 24 and drops back down toward the second zone 3 in liquid form. The refrigerating fluid is at least heated, and if it is a liquid, it is preferably vaporized, at least in part, in the passages 24.

The matrix 1 possibly comprises means (not illustrated) for extracting gaseous nitrogen at the top of the passages 22 of the second zone 3.

It will be appreciated that detail of the plates is illustrated only in the right-hand part of FIG. 1A, but that the entire matrix is configured in the way shown on the right.

In FIG. 1B a single plate 5 is positioned between each pair of plates 4 to form two passages 24. A partition blocks off the end of one passage 24 in two.

In FIG. 1C three plates 5 are positioned between each pair of plates 4 to form four passages 24. A partition blocks off the end of one passage 24 in two.

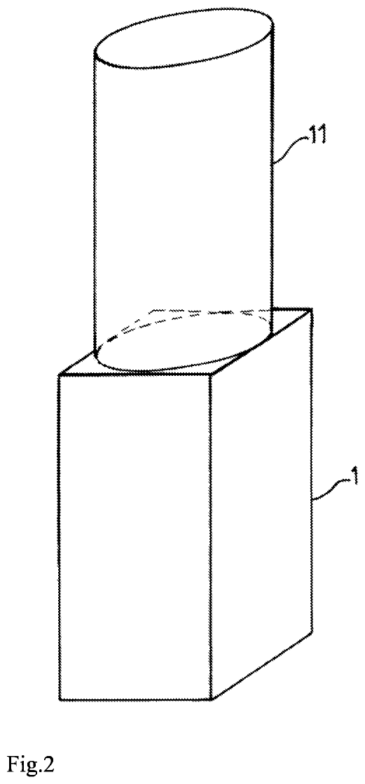

FIG. 2 shows the instance in which the matrix is associated with a distillation column having a cylindrical shell 11. The refrigerating fluid vaporized in the passages 24 of the first zone 3 is the result of a liquid falling from the column 11 which is the refrigerating fluid.

This column may for example separate the oxygen-enriched liquid coming from the passages 22 of the second zone 3. An oxygen-rich liquid formed at the bottom of the column is supplied to some of the passages of the matrix 1 in the first zone 2.

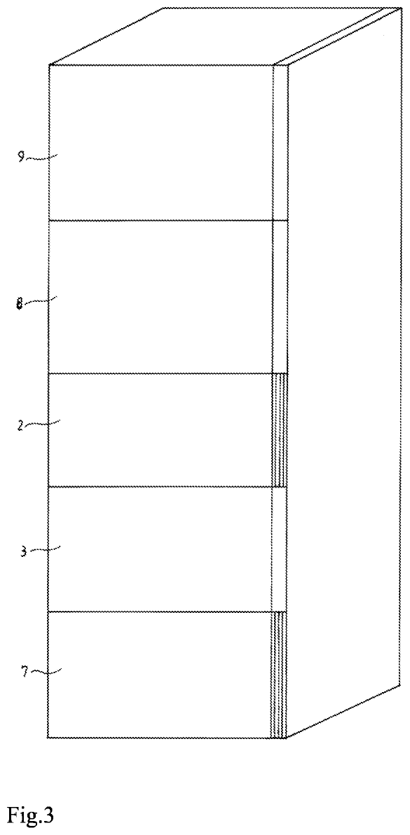

FIG. 3 illustrates a matrix comprising a stack of several plates arranged parallel to one another in a direction known as the direction of stacking, the matrix having a length, a width and a height, the length of a matrix being the greatest dimension of the parallel plates, the width of the matrix being measured perpendicular to the length, and the height of the matrix being measured in the direction of stacking of its plates, each plate having the same length and the same width as the matrix, like that in FIG. 1A.

The matrix comprises five zones, these being a first zone 2, arranged between the four other zones, two above the first zone 2 and two below the first zone 2. The zone 2, referred to as the indirect heat-exchange zone, is defined by a first fraction of the length of the matrix, the total width of the matrix and the total thickness of the matrix.

It is situated just above a second zone 3, referred to as the distillation separation zone, defined by a second fraction of the length of the matrix, the total width of the matrix and the total thickness of the matrix.

The first zone 2 and the second zone 3 are connected and the matrix being constructed to allow fluid coming from just some of the passages of the first zone to communicate with the passages of the second zone, and to allow fluid coming from the passages of the second zone to communicate with just some of the passages of the first zone, over the entire section.

The zones 2 and 3 have already been described with respect to FIG. 1A and will not be described again.

Below the second zone 3 there is a zone 7 which is an indirect heat-exchange zone.

Above the first zone 2 there are two zones 8, 9 which are distillation zones. In the zone 7, different passages are assigned to different fluids so that there is no transfer of material between the passages or within the passages of the zone.

This zone 7 is used for example to cool air that is to be separated down to a cryogenic temperature by indirect exchange of heat with at least one product of the distillation which is warmed up in other passages of the zone 7 to a temperature close to ambient temperature.

The number of passages in the zone 7 is strictly greater than the number of passages in the second zone 3 and preferably a multiple of the number of passages in the second zone. The number of passages in the zone 7 may be equal to or less than or greater than the number of passages in the first zone 2. The number of passages in the zone 7 is at least twice, or even at least three times, or even at least eight times as high as the number of passages in the second zone 3.

The increase in the number of passages is obtained by positioning plates 5 parallel to the plates 4, the plates 5 being shorter than the plates 4 and having a length corresponding to the length of the zone 7.

The passages in the zone 7 contain means for encouraging the exchange of heat and selected from the group: straight corrugations, perforated corrugations, serrated (partially offset) corrugations, louvered corrugations and herringbone corrugations.

The zones 8 and 9 preferably have a number of passages similar to those of the second zone, these zones also being devoted to distillation.

As a quick description of how the matrix works to achieve cooling and distillation corresponding to those functions performed by a double column air separation apparatus, the steps are as follows:

The air is cooled down to a cryogenic temperature in dedicated passages of the zone 7 and at least part of the cooled air is then distributed to all or at least a large majority of the passages of the zone 3 where it is separated into a nitrogen-enriched gas and an oxygen-enriched liquid, The nitrogen-enriched gas enters certain passages of the zone 2, condenses therein, and drops back down to all the passages of the zone 3.

The oxygen-enriched liquid of the zone 3 and some of the nitrogen condensed in the zone 2 are sent to the zones 8 and 9 respectively, where they separate at a pressure lower than that of the zone 3.

An oxygen-rich liquid drops to the base of the zone 8 and enters passages of the zone 2 that are not supplied with the nitrogen from the zone 3.

An exchange of heat between the nitrogen-supplied passages of the zone 2 and the oxygen-supplied passages of the zone 2 produces the condensed nitrogen already mentioned, as well as vaporized oxygen which rises up into the zone 8 and is used as the product that is warmed up in the zone 7 in exchange with the air. At least one nitrogen-enriched gas taken from the zone 9 is also warmed up there.

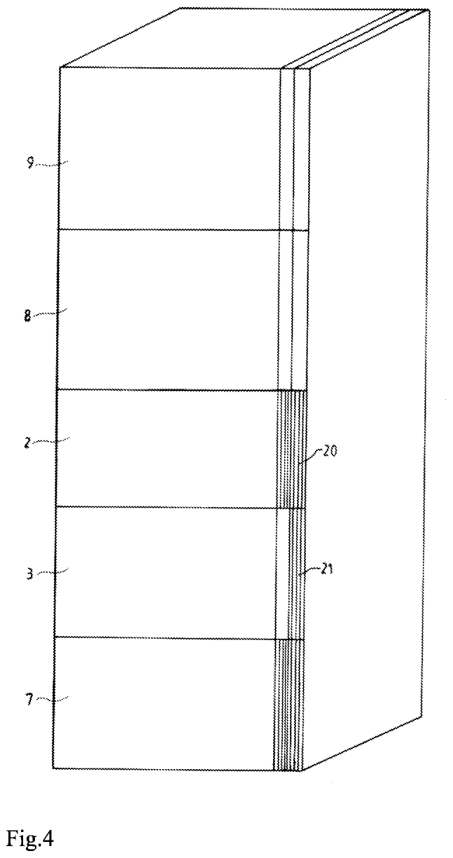

FIG. 4 illustrates a matrix comprising a stack of several plates arranged parallel to one another in a direction known as the direction of stacking, the matrix having a length, a width and a height, the length of a matrix being the greatest dimension of the parallel plates, the width of the matrix being measured perpendicular to the length, and the height of the matrix being measured in the direction of stacking of its plates, each plate having the same length and the same width as the matrix, like that in FIG. 1A.

The matrix comprises seven zones, these being a first zone 2, arranged between the four other zones, two above the first zone 2 and two below the first zone 2. The zone 2, referred to as the indirect heat-exchange zone, is defined by a first fraction of the length of the matrix, the total width of the matrix and at least half the total thickness of the matrix. The zones 7, 3, 8 and 9 correspond to the same functions as those described in respect of FIG. 3. The zones 7, 8 and 9 occupy the total width of the matrix and the total thickness. Like the zone 2, the zone 3 occupies only at least half the stack, and each occupies the total width of the matrix. The rest of the stack facing the zones 2 and 3 is used for indirect heat-exchange zones 21 and 20. In the case of the separation of the air gases, this may be the supercooling of rich liquid in the case of the zone 21 and the supercooling of poor liquid in the case of the zone 20.

It is also conceivable to create these indirect-exchange zones intended for the supercooling of the rich and poor liquids by using a small fraction of the width of the matrix.

In general, small fractions of the stack and/or of the width can be used for the following functions in the case of the separation of the air gases: mixing column, Etienne column, supercooler, auxiliary evaporator, pipework (for example square or rectangular) for circulating a fluid in two zones of the matrix, argon mixture column with its condenser, column for removing nitrogen from the argon with its condenser and its reboiler.

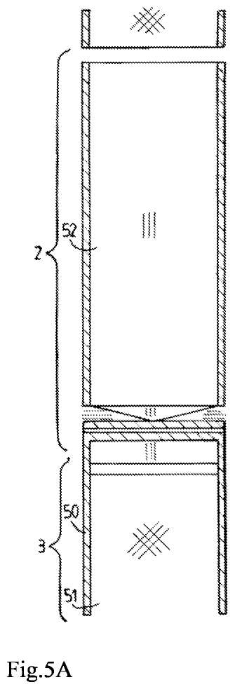

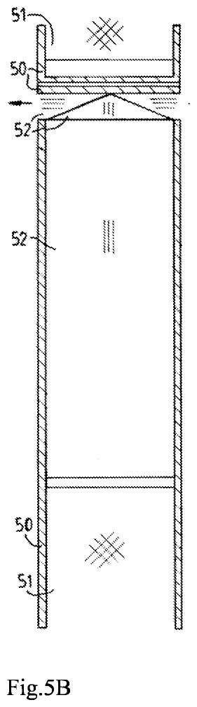

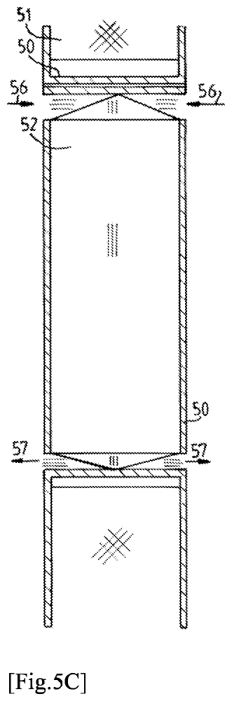

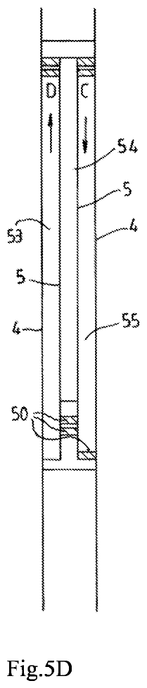

FIGS. 5A, 5B, 5C and 5D depict another preferred embodiment of the invention in which the chosen number of passages in the zone 2 is multiplied by a number which is a multiple of 3 (preferably 3, 6 or 9), so as to have 2 heating passages 1 a flanking 1 refrigerating passage (or possibly the reverse). FIG. 5A depicts a refrigerating passage layout for the zone 2. FIG. 5B depicts a passage layout for a first heater which operates as a condenser-dephlegmator, which is to say that the gas coming from the zone 3 will condense as it flows in a counterflow manner with respect to the condensed liquid. In this case, there is an indirect transfer of heat with the adjacent refrigerating passage and a transfer of material between the ascending gas and the liquid descending inside the passage. The liquid leaving these passages directly provides the reflux in the zone 3. FIG. 5C depicts a passage layout for a second heater which operates as a condenser; the gas circulates downward in a parallel-flow manner with respect to the liquid which condenses. FIG. 5D depicts a side view (or view in cross section) of the three passages, with the passage of FIG. 5A between the passages of FIGS. 5B and 5C. The elements 50 represent the sidebars that close the passages. The elements 51 (diagonal cross-hatching) represent, like the passages 22 in FIGS. 1B and 1C, means for encouraging the transfer of material between a liquid phase and a gas phase. The elements 52 represent exchange or distribution corrugations, the hatching determining the direction of the corrugations. In order to prevent leaks between a refrigerating passage and a heating passage, a double bars 50 system is employed, at the bottom of the refrigerating passage and at the top of the heating passages. The zone between the two bars is at a pressure lower than that of the refrigerating and heating passages. A box to the side may collect the leaks.

FIG. 5D shows a pair of plates 4 separated by two plates 5 to form the three passages, the heating second passage 55 being indicated by a letter C and an arrow to indicate the liquid which condenses and flows downward. The first passage 53, being a dephlegmation passage, is indicated by a letter D.

The group of plates in FIG. 5D is positioned between two other identical groups of plates such that the second passage 55 sits alongside a first passage 53 of an adjacent group. Likewise, the first passage 53 is next to a third passage 55 of an adjacent group. In this way, the gas from a first passage can enter a third passage.

This transfer of gas is indicated by 56 in FIGS. 5B, 5C.

The rising gas in zone 3 enters the heating first passage 53 where it partially condenses. The non-condensed part is extracted at the top of the passage to be distributed to the heating second passage 55 where it will condense almost completely.

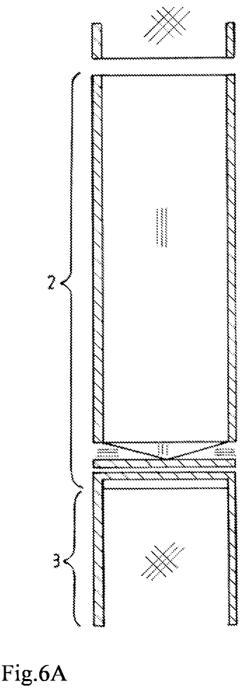

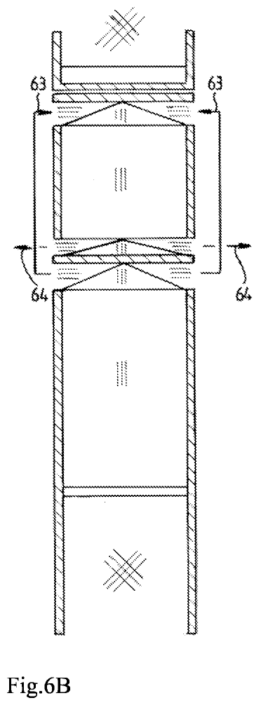

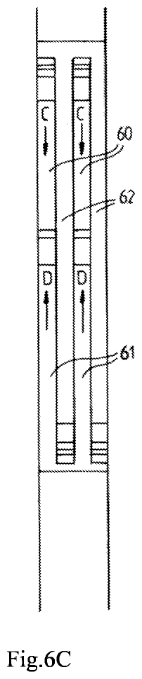

FIGS. 6A, 6B and 6C depict another preferred embodiment of the invention in which the chosen number of passages in the zone 2 is multiplied by a number which is a multiple of 4. FIG. 6A depicts a refrigerating passage 62 layout for the zone 2. FIG. 6B depicts a layout for a heating passage which operates as a condenser-dephlegmator D in its lower part 61 and as a condenser C in its upper part 60. FIG. 6C depicts a side view (or view in cross section) of the passages formed between a pair of plates 4 which are separated by three plates 5 to form four passages, of which two 62 are refrigerating passages and two are heating passages.

The rising gas in the zone 3 enters the bottom section of the heating passages 61 where it partially condenses. The non-condensed part 64 is extracted at the top of this section 61 to be distributed to the top of the top section of the heating passages 60 where it will condense almost completely.

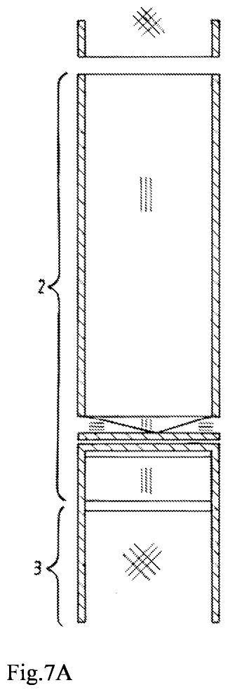

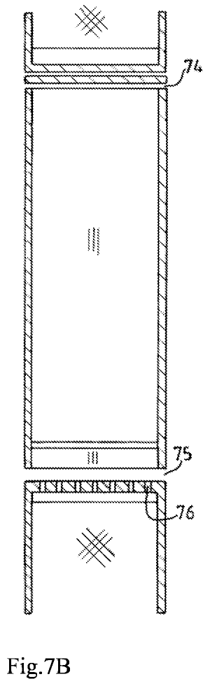

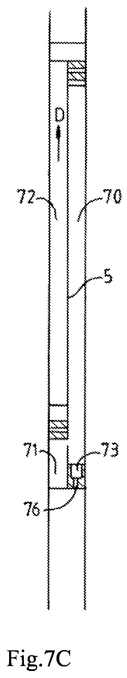

FIGS. 7A, 7B and 7C depict another preferred embodiment of the invention in which the chosen number of passages in the zone 2 is multiplied by a number which is a multiple of 2. In this instance, a pair of plates 4 is separated by one plate 5. FIG. 7A depicts a refrigerating passage layout for the zone 2. FIG. 78 depicts a layout for heating passages which operates as a condenser-dephlegmator D. FIG. 7C depicts a side view (or view in cross section) of the two passages 70, 72.

To prevent the rising gas in the zone 3 from encountering the liquid that is collected in the zone 73, the bottom section 71 of the refrigerating passages 72 is used as passages through which to pass the gas. An opening (or openings) in the separator sheet 5 allows the gas to enter the section 70 which operates as a condenser-dephlegmator. To create this opening, the separator sheet 5 may for example be in two pieces with a space between the two. The gas enters the bottom section of the heating passages 70 where it partially condenses. At the top of the section 70, it is potentially possible for uncondensables or some of the gas to be extracted via the opening 74. The falling liquid from the section 70 is collected in the section 73 so as:
to be able to extract a fraction thereof via the opening 75 and, for example, provide reflux for a zone 9 as depicted in FIG. 3.
to be able to distribute the liquid via calibrated orifices 76 to provide reflux for the zone 3.

Such devices may also be applied to methods other than the separation of the air gases.

The distribution of fluids passing from one zone to another may be performed as illustrated in U.S. Pat. No. 5,144,809, using header tanks to extract the fluids from one zone and transfer them into another zone.

For all the figures, the collection of passages 23 of the first zone 2 have a dimension which is the first fraction of the length of the matrix, a dimension which is at least half the total width of the matrix, and a dimension which is at least at least half the thickness of the matrix. The collection of passages 22 of the second zone 3, 7, 8, 9 have a dimension which is the second fraction of the length of the matrix, a dimension which is at least at least half the total width of the matrix, and a dimension which is at least half the thickness of the matrix, each passage being defined between two successive plates and extending parallel to a longitudinal axis.

It is conceivable to incorporate into the matrix means for sending a heating fluid into the first series of the passages of the first zone 2 and means for sending a liquid that is to be vaporized into the second series of the passages of the first zone 2.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-19. (canceled)

20. A matrix, configured to form at least part of a material-transfer separation unit, the matrix comprising a stack of several plates arranged parallel to one another in a direction known as the direction of stacking, thereby defining passages, the matrix having a length, a width and a thickness, the length of a matrix being the greatest dimension of the parallel plates, the width of the matrix being measured perpendicular to the length, and the thickness of the matrix being measured in the direction of stacking of the plates,
each plate having the same length and the same width as the matrix,
the matrix comprising at least two zones, including a first zone referred to as indirect heat-transfer zone, defined by a first fraction of the length of the matrix, at least half the total width of the matrix and at least half the total thickness of the matrix, and a second zone referred to as the distillation-separation zone, defined by a second fraction of the length of the matrix, at least half the total width of the matrix and at least half the total thickness of the matrix,
the first zone and the second zone being connected and the matrix being constructed to allow fluid coming from just some of the passages of the first zone to communicate with the passages of the second zone, and to allow fluid coming from the passages of the second zone to communicate with at least some of the passages of the first zone,
the collection of passages of the first zone having a dimension which is the first fraction of the length of the matrix, a dimension which is at least half the total width of the matrix, and a dimension which is at least at least half the thickness of the matrix,
the passages of the first zone containing a means to encourage indirect heat transfer and/or material transfer, and the passages of the second zone containing means to encourage the transfer of material between a liquid phase and a gas phase,
the passages of the first zone consisting of a first series of passages to channel at least one refrigerating or heating fluid, the passages of the first series not being in fluidic communication with the second zone, and a second series of passages for channelling a fluid produced by distillation in the second zone, the passages of the second series being in fluidic communication with the second zone, the passages of the first zone being closed in order to prevent the fluid produced by the material transfer from entering the first series and in order to prevent the refrigerating or heating fluid from entering the second series,
the collection of passages of the second zone having a dimension which is the second fraction of the length of the matrix, a dimension which is at least at least half the total width of the matrix, and a dimension which is at least half the thickness of the matrix, each passage being defined between two successive plates and extending parallel to a longitudinal axis, and
the number of passages in the first zone being strictly greater than the number of passages in the distillation second zone.

21. The matrix as claimed in claim 20, wherein the number of passages in the first zone is at least twice as high as the number of passages in the second zone.

22. The matrix as claimed in claim 20, wherein the passages in the first zone contain means for encouraging the indirect transfer of heat and selected from the group: straight corrugations, perforated corrugations, serrated corrugations, louvered corrugations and herringbone corrugations.

23. The matrix as claimed in claim 20, wherein the passages of the second zone contain a means for encouraging the transfer of material between a liquid phase and a gas phase and chosen from the group: structured packings made up of superposed corrugated strips, possibly contained within a row of polygonal-section columns, and random-fill packings.

24. The matrix as claimed in claim 20, further comprising at least a third zone referred to as a material-transfer zone adjoining the first zone, the matrix being constructed in such a way as to allow fluid from the passages of the first zone to communicate with the passages of the third zone and fluid from the passages of the third zone to communicate with the passages of the first zone, throughout the section, the third zone, referred to as the second material-transfer zone, defined by a third fraction of the length of the matrix, the total width of the matrix and the total thickness of the matrix
the passages of the third zone having a dimension which is a third fraction of the length of the matrix, a dimension which is the total width of the matrix, and a dimension which is the thickness of the matrix,
the passages of the third zone containing means to encourage material transfer, the number of passages in the first zone being strictly greater than the number of passages in the distillation third zone.

25. The matrix as claimed in claim 20, further comprising at least a third zone referred to as an indirect heat-transfer zone adjoining the second zone, the matrix being constructed in such a way as to allow fluid from the passages of the second zone to communicate with the passages of the third zone and/or fluid from the passages of the third zone to communicate with the passages of the second zone, throughout the section, the third zone, referred to as the second indirect heat-transfer zone, defined by a third fraction of the length of the matrix, at least half the total width of the matrix and at least half the total thickness of the matrix,
the passages of the third zone having a dimension which is a third fraction of the length of the matrix, a dimension which is at least half the total width of the matrix, and a dimension which is at least half the thickness of the matrix,
the passages of the third zone containing a means for encouraging indirect heat transfer and/or material transfer,
the number of passages in the third zone is strictly greater than the number of passages in the material-transfer second zone.

26. The matrix as claimed in claim 25, wherein the number of passages in the third zone is equal to the number of passages in the first zone.

27. The matrix as claimed in claim 20, wherein the plates are made of aluminum.

28. The matrix as claimed in claim 20, wherein the means for encouraging the transfer of material between a liquid phase and a gas phase in the passages of the second zone are not brazed to the plates of each passage.

29. The matrix as claimed in claim 20, wherein the means for encouraging the exchange of heat in the passages of the first zone are brazed to the plates of each passage.

30. The matrix as claimed in claim 20, wherein the passages of the second zone are each defined between two adjacent plates of the matrix.

31. The matrix as claimed in claim 20, wherein at least one planar element is arranged between each pair of adjacent plates, the planar element being parallel to the plates and dividing the space between two plates in the first zone to define the passages of the first zone.

32. The matrix as claimed in claim 20, wherein the passages of the first series and of the second series of the first zone have a height which is at least a factor of two smaller than the height of the passages of the second zone.

33. The matrix as claimed in claim 20, wherein the passages of the first zone are between at least one planar wall parallel to the plates and i) one of the plates or ii) another planar wall parallel to the plates.

34. The matrix as claimed in claim 20, further comprising a means for supplying all the passages of the second zone with the same fluid.

35. The matrix as claimed in claim 20, further comprising a means for sending gas from each passage of the second zone to just some of the passages of the first zone across the entire section.

36. The matrix as claimed in claim 20, wherein the second zone comprises a multitude of passages adjacent to one another.

37. An apparatus for separating a gas mixture having at least two components using a matrix as claimed in claim 20, the passages of the first zone each having a first end and a second end, the passages of the second zone each having a first end and a second end, the second ends of the passages of the first zone being juxtaposed with the first ends of the passages of the second zone, the apparatus comprising a means for sending the cooled and purified gas mixture into the second ends of at least the majority of the passages of the second zone, a means for extracting a liquid enriched in one component of the gas mixture from the second ends of the passages, as well as:
i) a means for sending a refrigerating fluid into the first series of the passages of the first zone and a means for sending a gas that is to be condensed into the second series of the passages of the first zone and/or
i) a means for sending a heating fluid into the first series of the passages of the first zone and a means for sending a liquid that is to be vaporized into the second series of the passages of the first zone.

38. A method for separating a gas mixture by cryogenic distillation wherein the distillation is performed by means of a matrix as described in claim 20 and wherein:
i) A gas produced by the distillation of the gas mixture in the second zone condenses in the first zone through exchange of heat with a refrigerating fluid, and/or
ii) A liquid produced by the distillation of the gas mixture vaporizes in the second zone through exchange of heat with a heating fluid.
